(19) United States
(12) Patent Application Publication
(10) Pub. No.: US 2008/0217154 A1
(43) Pub. Date: Sep. 11, 2008

(54) Contact Arrangement with a Limiting Element, Which Limits the Deflection of the Moveable Contact Piece

(75) Inventor: Peter Stenzel, Falkensee (DE)

Correspondence Address: LERNER GREENBERG STEMER LLP, P O BOX 2480, HOLLYWOOD, FL, 33022-2480, US

(73) Assignee: SIEMENS AKTIENGESELLSCHAFT, Munich (DE)

(21) Appl. No.: 12/064,828

(22) PCT Filed: Aug. 9, 2006
(86) PCT No.: PCT/EP2006/065182

§ 371 Date: Feb. 26, 2008

(30) Foreign Application Priority Data
Aug. 26, 2005 (DE) 10 2005 041 637.3

(51) Int. Cl. H01H 31/28

(52) U.S. Cl. 200/48 R

(57) ABSTRACT

A contact assembly for a grounding switch or circuit breaker includes a first and second contact piece. The two contact pieces can be displaced in relation to one another. At least one of the contact pieces is allocated to a limiting element, which restricts a deflection of the contact piece transversely to the displacement path. When closed, the limiting element connects the second contact piece to a support element.

The invention relates to a contact arrangement of a grounding switch or a switch disconnector with a first and a second contact piece, which are capable of moving along a movement path relative to one another.

Such a grounding switch is known from the Swiss patent specification CH 480 725. In this document, additional grounding switches are arranged at outdoor bushings for passing out electrical connections of a circuit breaker with a dead-tank design. The grounding switches each have a first contact piece, which can be pivoted on a circular arc, and a second contact piece, which is fixed in position. In the switched-on state of a grounding switch, a current path, which is arranged in the interior of the associated outdoor bushing, and a grounding current path of the grounding switch run approximately parallel. In the event of a fault, a current can flow via the current path arranged in the interior of the outdoor bushing and the grounding switch towards ground potential. The current path arranged in the interior of the outdoor bushing and the grounding current path of the grounding switch have one and the same current flowing through them, but this current has opposite flow directions as a result of the geometrical conditions. Magnetic fields brought about by the current flow result in repelling forces between the current path and the grounding current path owing to the throughflow in opposite directions. Owing to the forces, mechanical loading of the arrangement and therefore also of the contact arrangement takes place. As a result, the contact pieces threaten to be lifted off from one another and to produce arcs. There is also the risk of the contact point opening in uncontrolled fashion.

The invention is therefore based on the object of specifying a contact arrangement of the type mentioned at the outset which ensures safe contact-making between contact pieces which are capable of moving relative to one another and also prevents contact interruption under problematic conditions.

In a contact arrangement of the type mentioned at the outset, the object is achieved according to the invention by virtue of the fact that at least one of the contact pieces has an associated limiting element, which limits a deflection of at least one movable contact piece transversely with respect to the movement path.

The contact pieces are arranged in such a way that they are capable of moving relative to one another. At least one of the contact pieces is mounted movably. During a switch-on movement, at the end of the movement contact-making takes place between the two contact pieces. This contact-making takes place, for example, by means of the contact pieces moving into one another. Typically, such a contact arrangement is a sliding or plugging contact arrangement, which can be closed and opened a plurality of times. However, such contact arrangements, owing to the required spring-elastic contact-making, are dependent on sufficient stabilization of the position of the contact pieces in the respective end positions taking place. As a result of the use of a limiting element, a transverse deflection of the contact pieces is avoided. They can therefore be prevented from unintentionally moving out of, for example, an end position owing to external forces, which can originate, for example, from force effects between magnetic fields of conductors through which current is flowing. The contact pieces themselves remain protected against additional bending loads. As a result, the life of the contact pieces is extended and safe contact-making is ensured. Such contact arrangements can be used on different switching devices, for example on switch disconnectors, load switch disconnectors, grounding switches or so-called high-speed grounding switches.

A further advantageous configuration can provide that the movement path runs in a plane, and the limiting element absorbs forces acting transversely with respect to the plane.

Movement paths which run in a plane can be produced easily by corresponding drive arrangements or gear mechanisms. Thus, for example, it can be provided that the relative movement between the two contact pieces is performed along a line. A further advantageous movement form represents a pivoting movement, at least one of the contact pieces being pivoted about an axis of rotation. The pivoted contact piece in this case moves at a radial distance from the axis of rotation. In a simple case, this radial distance remains constant, so that at least one segment of a circular path is covered. As a result of the use of a limiting element, a necessary rotary bearing can have a simplified design since transverse forces are absorbed by the limiting element. In this case, provision can be made that, depending on the transverse forces occurring, the limiting element is configured in such a way that the entire movement path is stabilized by the limiting element or else only sections or points of the movement path are secured by the limiting element.

An advantageous configuration can provide that the first contact piece is arranged at one end of a movably mounted supporting element and, in a closed state of the contact arrangement, the limiting element supports the supporting element on the second contact piece and/or a holding element of the second contact piece.

The limiting element should in this case be configured in such a way that, in the closed state, the contact arrangement is mechanically bridged, so that forces are guided outside the contact pieces, which are provided for the electrical contact-making. As a result, the actual electrical contact-making point is protected against mechanical overloads. Provision can be made, for example, that the limiting element is added to the contact arrangement once the switch-on position has been reached in order to absorb mechanical forces. However, provision can also be made that the limiting element is fastened, for example, to the stationary second contact piece and the movable first contact piece is supported by the limiting element on reaching its switch-on position.

Furthermore, it can advantageously be provided that the limiting element is attached to the supporting element.

In order to produce a circular movement path, a supporting element can be mounted pivotably, the first contact piece being arranged on the supporting element spaced apart from the axis of rotation. An angularly rigid connection between the supporting element and the limiting element represents a cost-effective variant of a way of attaching the limiting element. In the event of a pivoting movement of the supporting element, the first contact piece is correspondingly concomitantly moved. In a simple case, in order to produce the circular path it can be provided that the supporting element remains unchanged in terms of its shape during a pivoting movement. However, it can also be provided that the supporting element itself is changed in terms of its shape during a pivoting movement. For example, telescopic extensions can be extended or movement paths can be produced by means of pantographic transfers, which movement paths neither correspond to a linear movement nor to a circular movement.

In the closed state, securing of the contact arrangement by means of the limiting element is particularly important since, in this state, reliable, interruption-free contact-making of the first and the second contact piece is assumed. In particular when using sliding or plugging contact arrangements between the first and the second contact piece, the contact arrangement itself is protected against external mechanical loads. Furthermore, a risk which may occur as a result of the contact pieces lifting off from one another at least temporarily owing to deflections is avoided. In particular in the case of a safety-relevant contact arrangement, such as on grounding switches, for example, this is to be avoided if possible. Furthermore, when the contact pieces lift off from one another, there is the risk of a load current, grounding current or charge current etc. bringing about arc phenomena at the contact arrangement. These arc phenomena can result in contact erosion, as a result of which the life of the contact arrangement itself is adversely affected.

An advantageous configuration can provide that the second contact piece is mounted fixed in position.

As a result of the fact that the second contact piece is mounted fixed in position, a mechanically simple contact arrangement is produced. It is only necessary for the first contact element to move on a corresponding movement path in order to produce a contact or open the contact arrangement. Furthermore, the second contact piece can be designed to be comparatively solid since movements do not need to be performed, for example, by corresponding drive devices. Owing to a stable configuration, the second contact piece can be used as the mechanically stabilizing element of the contact arrangement.

Advantageously, in this case it can further be provided that the limiting element connects the second contact piece and/or the holding element in electrically insulating fashion to the supporting element.

An electrically insulating connection between the second contact piece and/or holding element and the limiting element prevents the formation of parallel current paths on the contact arrangement. Such parallel current paths can result in undesirable discharge phenomena and heating phenomena. As a result, the stability of the contact arrangement itself can be adversely affected. For electrical insulation purposes, a corresponding insulating mounting of the limiting element can be provided, for example. Electrically insulating mounting can be provided, for example, in the region of an angularly rigid connection to the supporting element. However, it can also be provided that corresponding insulating sections are arranged over the profile of the limiting element.

An advantageous configuration can furthermore provide that the limiting element has a stop, which, in the closed state of the contact arrangement, extends laterally with respect to the movement path next to a stop point at the second contact piece and/or the holding element.

As a result of the use of an electrically insulating stop on the limiting element, a further possibility is provided for electrically insulating the limiting element. Advantageously, it can also be provided for this purpose, for example, that the limiting element is formed almost completely from an electrically insulating material. This electrically insulating material can be, for example, an inorganic material, such as a ceramic, for example, an organic material, such as wood, or a plastic, such as polytetrafluoroethylene or fiber-reinforced plastics, for example. The use of a plastic furthermore has the advantage that it has sufficient resistance to breakage given a low mass and sufficient elasticity is provided during absorption of transverse forces. Owing to the arrangement of stops of the limiting element on both sides of the movement path adjacent to the second contact piece, forces from different directions can act on the contact arrangement. The transverse forces can act at different angles substantially transversely with respect to the movement path and can be absorbed by the limiting element. In order to form a stop on both sides of the movement path adjacent to the second contact piece, a fork-shaped configuration of the limiting element can be provided, for example, which configuration has a cutout, into which the second contact piece enters in the course of it reaching a switch-on position. However, the stop can also be designed in such a way that it is arranged only on one side adjacent to the second contact piece. The mass of the limiting element is thus reduced. Such a design can advantageously be used when forces only act from one direction, with the result that the stop on one side is pressed against the second contact piece. The same applies if a holding element of the second contact piece is used in addition or as an alternative. As described above, the second contact piece can have a mechanically stable construction in such a way that forces occurring can be introduced into the second contact piece.

The stop is dimensioned in such a way that it only bears lightly against the second contact piece or is arranged at a slight distance. As a result, no additional push-on forces need to be applied.

In the advantageous configuration, it can furthermore be provided that the second contact piece is a blade contact piece.

Blade contact pieces have a robust, low-wear design. They are therefore particularly well suited for absorbing relatively high forces, such as may be transferred, for example, by the limiting element.

A further advantageous configuration can correspondingly provide that the first contact piece has mutually opposite, elastically deformable finger elements.

As the mating contact piece for a blade contact piece, the first contact piece can have, for example, elastically deformable finger elements, which can slide onto the blade contact piece. Owing to the elastic deformability, the finger elements are pressed onto the blade contact piece or the second contact piece. Frequent overelongation of the finger elements, for example as a result of transverse forces occurring, could result in premature ageing of the contact arrangement. As a result of the use of the limiting element, such overelongation and extension of the finger elements is avoided.

Furthermore, it can advantageously be provided that the supporting element is mounted pivotably.

A pivotable supporting element is suitable for using contact arrangements which are simple in design terms. A striking contact with a blade contact piece can be closed and opened in a simple manner.

The invention will be shown schematically in a drawing and described in more detail below with reference to an exemplary embodiment.

In the drawing

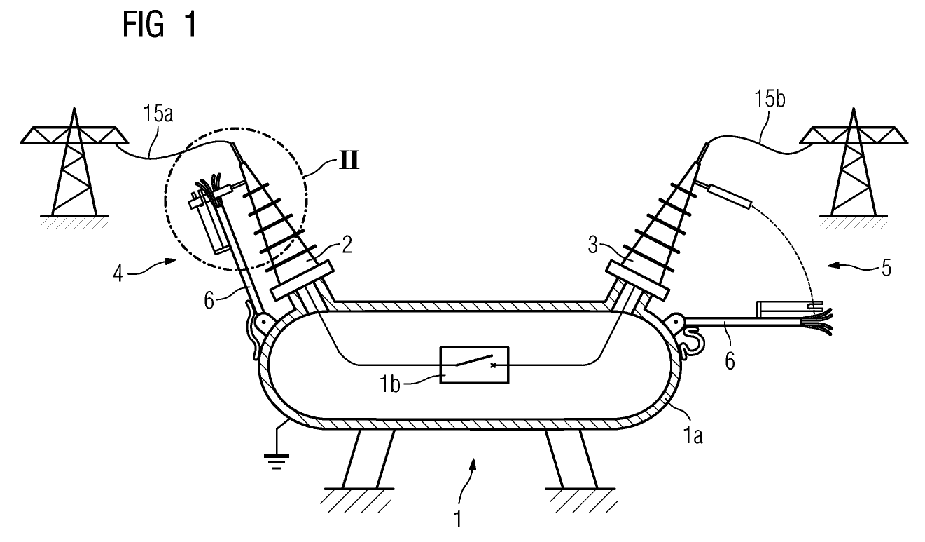

FIG. 1 shows a high-voltage circuit breaker with a plurality of contact arrangements,

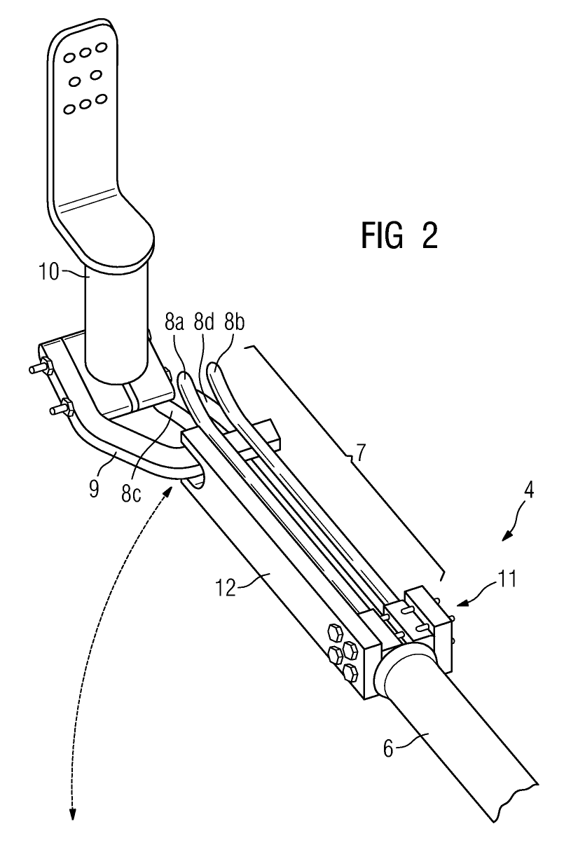

FIG. 2 shows a detail of a contact arrangement, and

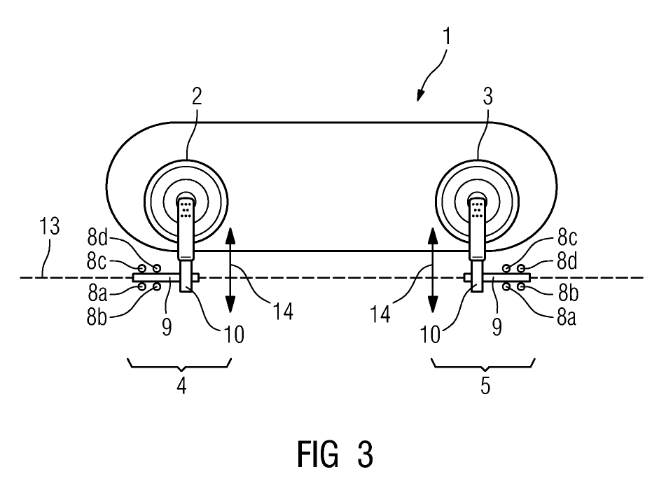

FIG. 3 shows a plan view of the high-voltage circuit breaker.

FIG. 1 illustrates a high-voltage circuit breaker 1 in a side view. The high-voltage circuit breaker 1 has a so-called dead-tank design, i.e. an interrupter unit 1b of a high-voltage circuit breaker 1 is arranged within a tank 1a, which is subject to ground potential and is manufactured from electrically conductive material. The interrupter unit 1b can be constructed, for example, in such a way that switch-disconnecting conditions are also met. As a result, separate switch disconnectors are no longer required. It can thus be provided that contact pieces of the interrupter unit 1b which are capable of moving relative to one another can be correspondingly far removed from one another in a switch-off position. In order to reduce the physical size of the high-voltage circuit breaker 1, the interior of the tank 1a is hermetically sealed and holds an electronegative gas, such as sulfur hexafluoride, for example under elevated pressure.

In order to guide electrical lines 15a, 15b into the interior of the tank 1a of the high-voltage circuit breaker 1, corresponding outdoor bushings 2, 3 are arranged at flanges of the tank 1a. It can be provided that, when using a high-voltage circuit breaker with a dead-tank design in electrical energy transmission systems with a plurality of phases, interrupter units having a plurality of phases are arranged within a common tank. Correspondingly, a larger number of outdoor bushings needs to be arranged on the tank of the high-voltage circuit breaker. However, alternatively it can also be provided that a configuration as that in FIG. 1 is provided, whereby a high-voltage circuit breaker 1 with a separate tank 1a is used for each phase of an electrical energy transmission system. For example, in order to switch a three-phase AC voltage system, three such high-voltage circuit breakers 1 are positioned next to one another.

In order to apply ground potential to the electrical lines 15a, b, which are connected at the connection points of the outdoor bushings 2, 3, grounding switches 4, 5 are provided. The grounding switches 4, 5 each serve the purpose of grounding the sections which are located on both sides of the interrupter unit 1b of the high-voltage circuit breaker 1. The grounding switches 4, 5 are each in the form of pivotable grounding switches, i.e. one of the contact pieces is moved on a circular pivoting path and, during a switch-on operation, enters a contact piece which is fixed in position and is arranged on the outdoor bushings 2, 3. Since the tank 1a of the high-voltage circuit breaker 1 conducts ground potential, it is advantageous to arrange the pivoting axis of the grounding switches 4, 5 in each case on the tank 1a of the high-voltage circuit breaker 1 and to provide corresponding electrical contact-making.

A supporting element 6, which is manufactured from electrically conductive material, is arranged at the axis of rotation. The supporting element 6 is electrically conductively connected to the tank 1a of the high-voltage circuit breaker 1. For example, a rotary bearing arrangement on the high-voltage circuit breaker 1 can be used for this purpose. Alternatively, however, it can also be provided that an electrically conductive connection, which can be subjected to a load, is formed by means of additional contact elements, such as flexible conductor cables or sliding contact arrangements, for example. However, it can also be provided that contact is made with the supporting element 6 by means of a separate grounding point and an electrically insulating connecting element is used on the tank 1a of the high-voltage circuit breaker 1. The grounding switch 4, which is illustrated in its switch-on position in FIG. 1, and the grounding switch 5, which is illustrated in its switch-off position in FIG. 1, have in principle the same design. In the text which follows, the design and the interaction of the contact pieces will now be described with reference to the grounding switch 4 illustrated in its switch-on position in FIG. 1.

FIG. 2 shows a detail of the grounding switch 4 illustrated in its switch-on position in FIG. 1. A first contact piece 7 is arranged on the supporting element 6 spaced apart from the axis of rotation thereof. The supporting element 6 and the first contact piece 7 are electrically conductively connected to one another. The first contact piece 7 has elastically deformable finger elements 8a, b, c, d arranged in pairs. The finger elements should be arranged in pairs, it being possible to select the number of pairs of finger elements depending on the power to be transmitted. In each case two of the finger elements are arranged opposite one another, with the result that an opening is formed between them, into which opening a second contact piece 9 can be introduced in the switched-on state of the grounding switch 4 under deformation of the finger elements 8a, b, c, d. As a result of the elasticity of the finger elements 8a, b, c, d, the latter bear against the second contact piece 9, so that a DC connection is provided. The second contact piece 9 is mounted fixed in position and is in the form of a blade contact piece. The second contact piece 9 is in this case designed in such a way that one section is shaped in the form of an arc, so that the finger elements 8a, b, c, d are first pressed against the convex curvature of the arc during a switch-on operation and a DC connection can be produced in a reliable manner. The second contact piece 9 is fastened on a holding element 10. The holding element 10 is correspondingly fastened on the outdoor-side end of the electrical conductor of an outdoor bushing 2. As a result, the second contact piece 9 is held by an outdoor bushing 2.

Furthermore, a connecting element 11 is arranged on the supporting element 6. The connecting element 11 is firstly used for fastening the first contact piece 7 on the supporting element 6. Secondly, the connecting element 11 is also used for the purpose of connecting a limiting element 12 to the supporting element 6 in a torsionally rigid manner. In the present example, the limiting element 12 is formed from a plastic and is designed to be substantially plate-shaped. The limiting element 12 can be configured in accordance with a predetermined bending moment characteristic. A uniform strength within the limiting element 12 which is clamped in at one end is thus produced. The limiting element 12 covers a large proportion of the first contact piece 7. At its end facing away from the connecting element 11, the limiting element 12 has a fork-shaped design. A cutout is formed between fork prongs of a fork, in which cutout, in the switched-on state as illustrated in FIG. 2, the second contact piece lies. The inner faces of the fork prongs are each supported on stop points of the second contact piece 9 which are positioned opposite one another. However, it can also be provided that, in addition or as an alternative, the holding element 10 or attachments arranged on the holding element 10 are use to support the limiting element 12. As a result of the fact that the limiting element 12 is constructed from an electrically insulating material, the formation of a parallel current path adjacent to the current path formed via the two contact pieces 7, 9 is avoided. Owing to the limiting element 12, forces lying transversely with respect to the movement path can be absorbed. This prevents the supporting element 6 with the first contact piece 7 fastened thereon from being deflected transversely with respect to the movement path. As a result of the use of the limiting element 12, the function of the transmission of an electrical current is transferred to the contact pieces 7, 9 at the mechanical points of contact. The mechanical holding and positioning of the first contact piece 7 with respect to the second contact piece 9 is ensured by the limiting element 12. In order to ensure corresponding stabilization, the pivotable supporting element 6 and the corresponding rotary bearing arrangement also need to be designed to be mechanically stable.

FIG. 3 shows a plan view of the high-voltage circuit breaker 1. In each case second contact pieces 9 with corresponding holding elements 10 are fastened to the outdoor bushings 2, 3 in angularly rigid fashion. FIG. 3 illustrates the two grounding switches 4, 5 in each case in their switch-on positions. The finger elements 8a, b, c, d of the respective first contact pieces 7 have been moved onto the associated second contact pieces 9. The pivoting path 13 of the first contact pieces 7 and of the supporting elements 6 are in this case aligned in such a way that the electrical current paths guided in the interior of the outdoor bushings 2, 3 lie outside the plane of the pivoting path 13. This ensures that the striking direction or entering directions of the contact arrangements is arranged transversely with respect to any transverse forces 14 which may occur. It can also be provided that the pivoting paths of the first contact pieces 7 lie in different planes.

Transverse forces 14 can arise, for example, as a result of the fact that a connection to ground occurs, which brings about a current flow through the electrical current paths, which are guided in the interior of the outdoor bushings 2, 3. The same electrical current is dissipated to ground via the corresponding grounding switches. This results in an arrangement of two electrical conductors, which lie approximately parallel to one another and through which in each case one current with a different directional sense flows, between the supporting element 6 and the current path in the interior of the outdoor bushing 2, 3. As a result of the correspondingly acting magnetic fields, repelling forces result between the two electrical conductors, which are guided approximately parallel. These repelling forces can be kept away from the contact pieces 7, 9 by an arrangement according to the invention of a limiting element 12.

1-10. (canceled)

11. A contact assembly of a grounding switch or a circuit breaker, comprising:
a first contact piece and a second contact piece movably disposed relative to one another along a movement path;
a limiting element associated with at least one of said first and second contact pieces and disposed to limit a deflection of said at least one contact piece transversely with respect to the movement path.

12. The contact assembly according to claim 11, wherein the movement path runs in a plane, and said limiting element absorbs forces acting transversely with respect to the plane.

13. The contact assembly according to claim 11, which comprises a movably mounted supporting element with a first end carrying said first contact piece, and wherein, in a closed state of the contact assembly, said limiting element is disposed to support said supporting element on said second contact piece and/or on a holding element of said second contact piece.

14. The contact assembly according to claim 13, wherein said limiting element is attached to said supporting element.

15. The contact assembly according to claim 11, wherein said second contact piece is mounted fixed in position.

16. The contact assembly according to claim 13, wherein said limiting element connects at least one of said second contact piece and said holding element to said supporting element through an electrically insulating connection.

17. The contact assembly according to claim 13, wherein said limiting element is formed with a stop, and said stop, in a closed state of said contact assembly, extends laterally with respect to the movement path next to a stop point at said second contact piece and/or said holding element.

18. The contact assembly according to claim 11, wherein said second contact piece is a blade contact piece.

19. The contact assembly according to claim 11, wherein said first contact piece is formed with mutually opposite, elastically deformable finger elements.

20. The contact assembly according to claim 11, which comprises a pivotally mounted supporting element having a first end carrying said first contact piece.
